(19) United States
(12) Patent Application Publication
(10) Pub. No.: US 2006/0033680 A1
(43) Pub. Date: Feb. 16, 2006

(54) Plasma display apparatus including an energy recovery circuit

(75) Inventor: Jeong Pil Choi, Suwon-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/219,858

(22) Filed: Sep. 7, 2005

(30) Foreign Application Priority Data
Sep. 7, 2004 (KR) 2004-0071468
Aug. 11, 2004 (KR) 10-2004-0063330

(51) Int. Cl. G09G 3/14

(52) U.S. Cl. 345/46; 315/169.2; 315/169.3

(57) ABSTRACT

The present invention generally relates a plasma display panel apparatus, and more particularly to a plasma display apparatus including an energy recovery circuit. A plasma display apparatus of the present invention includes a plasma display panel including an electrode, an energy supply and recovery unit which supplies and recovers the energy corresponding to a first voltage, an energy supply and recovery control unit which is adapt to supply the energy corresponding to said first voltage supplied by said energy supply and recovery unit to the electrode (ELD) through a supply path having a first inductance, and to recover the energy corresponding to said first voltage from said electrode to said energy supply and recovery unit through a recovery path having a second inductance, a voltage apply unit which applies a second voltage to said electrode after the energy corresponding to said first voltage is supplied to said electrode, and applies a third voltage to said electrode after the energy corresponding to said first voltage is recovered to said electrode, and a voltage maintenance unit which distributes a fourth voltage and maintains said first voltage constantly. The present invention can secure the stability of driving by constantly maintaining the energy stored in an energy store unit.

This Nonprovisional application claims priority under 35 U.S.C. § 119(a) on Patent Application No. 2004-0071468 filed in Korea on Sep. 07, 2004 the entire contents of which are hereby incorporated by reference.

### BACKGROUND OF THE INVENTION

1. Field of the Invention

The present invention relates a plasma display panel apparatus, and more particularly to a plasma display apparatus including an energy recovery circuit.

2. Description of the Background Art

FIG. 1 is a view illustrating a method of representing an image gray level of a conventional plasma display panel. As shown in FIG. 1, the image gray level is driving by dividing one frame into a number of sub fields whose number of the emission of light is different from each other. Each sub field is divided into a reset section which is to uniformly generate a discharge, an address section which is to select a discharge cell, and a sustain section which is to implement the gray level depending on the number of discharge. For example, a frame section (16.67 ms) correseponding to 1/60 sec is divided into 8 sub fields so as to display an image with 256 gray levels. In addition, each of 8 sub fields is divided again into an address section and a sustain section. Here, the sustain section is increased at the rate of 2n (n=0, 1, 2, 3, 4, 5, 6, 7) at each sub field, while the reset section and the address section of each sub field are not changed at every sub field.

On the other hand, a driving device for driving the plasma display panel includes a driving divice which applies alternate sustain voltage (Vs) to a Y electrode and a Z electrode in order to maintain the discharge of cell which is selected during the sustain period.

Such a driving device for driving the plasma display panel is included in a Y electrode driving unit and a Z electrode driving unit, respectively, the driving device for driving the plasma display panel included in each driving unit is as shown in FIG. 3.

FIG. 2 is a construction of a driving device of a conventional plasma display panel. FIG. 3 is a pulse form fomed by a conventional energy recovery circuit. As shown in FIGS. 2 and 3, the conventional driving device for driving the plasma display panel utilizes a energy recovery circuit to recover the unnecessarily generated energy, i.e. the reactive power, in the panel.

First, in state 1, a first switch Q1 is turned on, and a second to a fourth switch Q2, Q3, Q4 are turned off. Therefore, the energy stored in a capacitor Css is supplied to the panel Cp due to resonance, and thus the Vp rises. In state 1, as shown in FIG. 4, the current flowing in a inductor L is +IL, since it is supplied from the capacitor Css into the panel Cp.

In state 2, the first switch Q1 and the second switch Q2 are turned on, and the third switch Q3 and the fourth switch Q4 are tured off. As such, the Vp becomes the sustain voltage Vs. In the end time of the state 1, i.e. the time when the value of the Vp becomes maximum by LC resonance at t1, the sustain voltage Vs is applied to the panel Cp. Here, the sustain voltage Vs represents the voltage to maintain the discharge of the discharge cell.

Thereafter, in state 3, the third switch is turned on, and the first, the second, and the fourth switchs Q1, Q2, Q4 are turned off. Thus, the energy stored in the panel Cp is discharged to the capacitor Css by LC resonance, the energy is recovered, and the Vp drops. In state 3, the current flowing in the inductor L becomes −IL since the current flows from the panel Cp to the capacitor Css, as shown in FIG. 4

Finally, in state 4, the third and the fourth switchs Q3, Q4 are turned on, and the first and the second switchs Q1, Q2 are turned off. Thus, the Vp becomes a ground level. In the end time of the state 3, i.e. in t2, the Vp maintains the ground level.

The energy recovery circuit included in the conventional driving device for driving the plasma display panel utilizes only one inductor to recover and supply the energy, as mentioned above, and the conventional energy recovery circuit as such indicates the different the drive efficiency depending on the inductor L.

In other words, if the inductance of the inductor L is higher, then consumption power is reduced, and thus the drive efficiency of the energy recovery circuit becomes higher, on the contrary, the rise of voltage in the sustain pulse becomes gentle and a stronger discharge is difficult to be incurred, therefore there is a problem that the discharge efficiency is lessened.

Conventionally, the energy is made to be supplied through the inductor with a relatively low inductance in the time ER-up when the energy is supplied to the panel Cp, and the energy is made to be recovered through the inductor with a relatively high inductance in the time ER-down when the energy is recovered to the capacitor Css to solve the problem.

FIG. 4 is another example of the conventional energy recovery circuit. As shown in FIG. 4, the conventional energy recovery circuit supplies the energy from the capacitor Css to the panel Cp via a supply path which passes through the first switch Q1, a first diode D1, and a first inductor L1 in order.

In addition, the conventional energy recovery circuit has such a structure that the energy is recovered from the panel Cs to the capacitor Css via a recovery path which passes through a second inductor L2, a second diode D2, the third switch Q3 in order.

The conventional energy recovery circuit allows the rise of voltage to be fast since the energy of the capacitor Css is supplied to the panel Cp through the first inductor L1 with a relatively low inductance, thus generating a relatively stronger discharge and then improving the discharge efficiency. In addition, the conventional energy recovery circuit allows the energy of the panel Cp to be recovered to the capacitor Css through the second inductor L2 with a relatively high inductance, thus reducing the consumtion power.

FIG. 5 is another example of the conventional energy recovery circuit. As shown in FIG. 5, the conventional energy recovery circuit allows the energy to be supplied from the capacitor Css to the panel Cp via the supply path which passes through the first switch Q1, the first diode D1, and a first inductor L1′ in order. In addition, the conventional energy recovery circuit recovers the energy from the panel Cs to the capacitor Css via a recovery path which passes through the first inductor L1′, a second inductor L2′, a second diode D2, the third switch Q3 in order.

Here, the conventional energy recovery circuit allows the rise of voltage to be fast since the energy of the capacitor Css is supplied to the panel Cp only through the first inductor L1′, i.e. a relatively low inductance is generated at the energy supply path, thus generating a relatively stronger discharge and then improving the discharge efficiency. In addition, the conventional energy recovery circuit allows the energy of the panel Cp to be recovered to the capacitor Css through the first inductor L1′ and the second inductor L2′, i.e. a relatively high inductance is generated at the energy recovery path, thus reducing the consumtion power.

However, in such a structure that higher inductance is allowed to generated at the energy recovery path than the energy supply path and thereby the discharge efficiency is raised, the switching time of the energy supply and the energy recovery is different from each other and the inductance of the energy supply path and the energy recovery path is also different from each other, and thus it leads to an imbalance between the operation of the energy supplay and that of the energy recovery.

FIG. 6 is a pulse form formed by the conventional energy recovery circuit shown in FIGS. 4 and 5. As shown in FIG. 6, as times go on, the voltage Vcss of the energy stored in the capacitor Css is increasingly lessened than Vs/2 since the switching of the energy supply and the energy recovery is different from each other, and the inductance of the energy supply path and the energy recovery path is also different from each other in the conventional energy recovery circuit.

In other words, there is a possibility of loss of charges in the capacitor Css by saturation of the first inductor L1, L1′ because the energy supply process is performed by a relatively low inductance compared with the energy recovery process. In addition, there is a possibility that only smaller amounts of charges than capacitance of the capacitor Css is recovered to the capacitor Css by the relative increase of the energy stored in the second inductor L2 in FIG. 4 or the first inductor L1′ and the second inductor L2′ in FIG. 5 because the energy recovery process is performed by a relatively high inductance compared with the energy supply process. Therefore, there has been a problem that the voltage of the energy supplied to the panel Cp is instable and thus driving is also destablized.

### SUMMARY OF THE INVENTION

Accordingly, an object of the present invention is to solve at least the problems and disadvantages of the background art.

A plasma display apparatus of the present invention comprises a plasma display panel including an electrode; an energy supply and recovery unit which supplies and recovers the energy corresponding to a first voltage; an energy supply and recovery control unit which is adapt to supply the energy corresponding to said first voltage supplied by said energy supply and recovery unit to the electrode(ELD) through a supply path having a first inductance, and to recover the energy corresponding to said first voltage from said electrode to said energy supply and recovery unit through a recovery path having a second inductance; a voltage apply unit which applies a second voltage to said electrode after the energy corresponding to said first voltage is supplied to said electrode, and applies a third voltage to said electrode after the energy corresponding to said first voltage is recovered to said electrode; and a voltage maintenance unit which distributes a fourth voltage and maintains said first voltage constantly.

A plasma display apparatus according to the present invention comprises a plasma display panel including an electrode; an energy supply and recovery unit which supplies and recovers the energy corresponding to a first voltage; an energy supply and recovery control unit which is adapt to supply the energy corresponding to said first voltage supplied by said energy supply and recovery unit to the electrode(ELD) through a supply path having a first inductance, and to recover the energy corresponding to said first voltage from said electrode to said energy supply and recovery unit through a recovery path having a second inductance; a voltage apply unit which applies a second voltage to said electrode after the energy corresponding to said first voltage is supplied to said electrode, and applies a third voltage to said electrode after the energy corresponding to said first voltage is recovered to said electrode; and a voltage maintenance unit including a capacitor for control of the voltage which divides a fourth voltage to apply said first voltage to said energy supply and recovery unit.

A driving device of a plasma display panel of the present invention comprises a plasma display panel including an electrode; an energy supply and recovery unit which supplies and recovers the energy corresponding to a first voltage; an energy supply and recovery control unit which is adapt to supply the energy corresponding to said first voltage supplied by said energy supply and recovery unit to said electrode through a supply path having a first inductance, and to recover the energy corresponding to said first voltage from said electrode to said energy supply and recovery unit through a recovery path having a second inductance; a voltage apply unit which applies a second voltage to said electrode after the energy corresponding to said first voltage is supplied to said electrode, and applies a third voltage to said electrode after the energy corresponding to said first voltage is recovered to said electrode; and a voltage maintenance unit which distributes a fourth voltage and maintains said first voltage constantly.

The present invention can secure the stability of driving by constantly maintaining the energy stored in an energy store unit.

### BRIEF DESCRIPTION OF THE DRAWINGS

The invention will be described in detail with reference to the following drawings in which like numerals refer to like elements.

FIG. 1 is a method of representing an image gray level of a conventional plasma display panel.

FIG. 2 is an example of a conventional energy recovery circuit.

FIG. 3 is a pulse form formed by a conventional recovery circuit.

FIG. 4 is another example of a conventional energy recovery circuit.

FIG. 5 is still another example of a conventional energy recovery circuit.

FIG. 6 is a pulse form formed by a conventional recovery circuit shown in FIGS. 4 and 5.

FIG. 7 is a circuit of a plasma display apparatus according to a first embodiment of the present invention.

FIG. 8 is a circuit of a plasma display apparatus according to a second embodiment of the present invention.

FIG. 9 is a driving waveform of a plasma display apparatus according to the present invention.

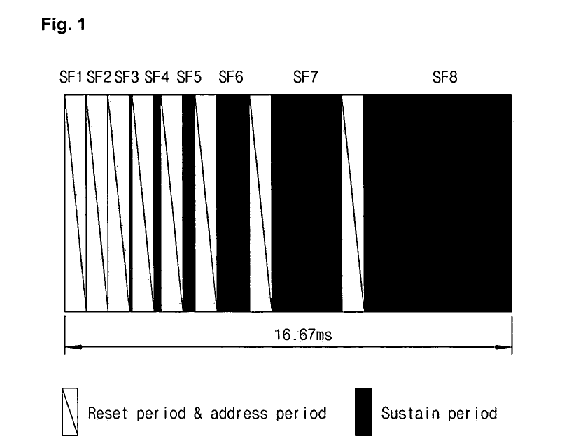

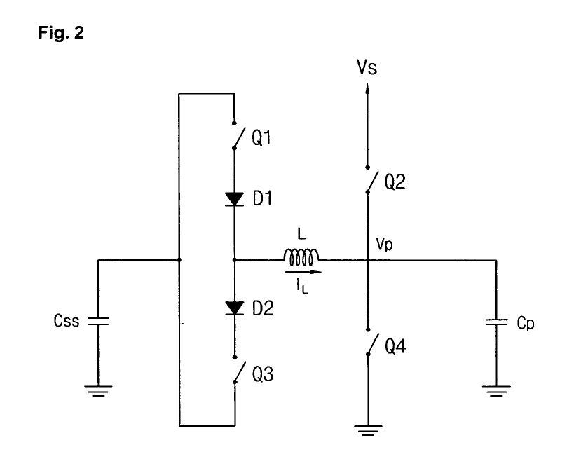

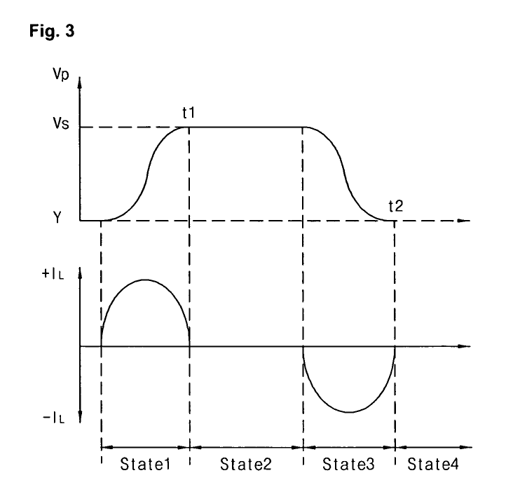

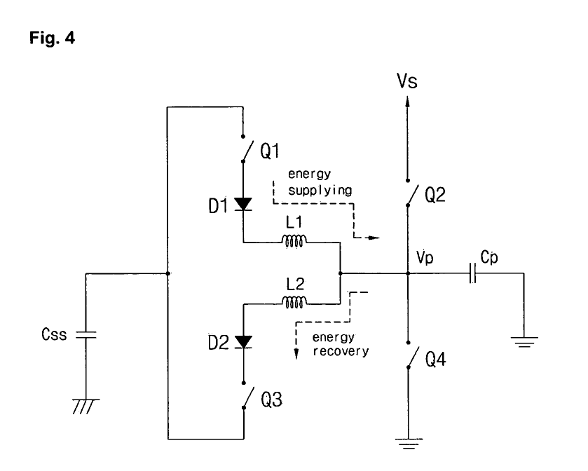

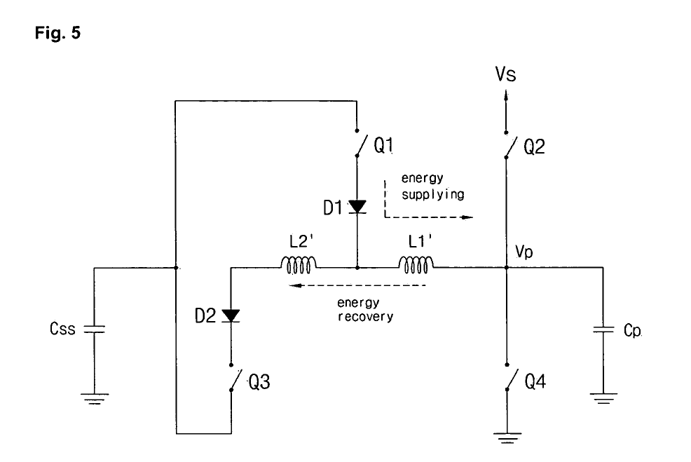

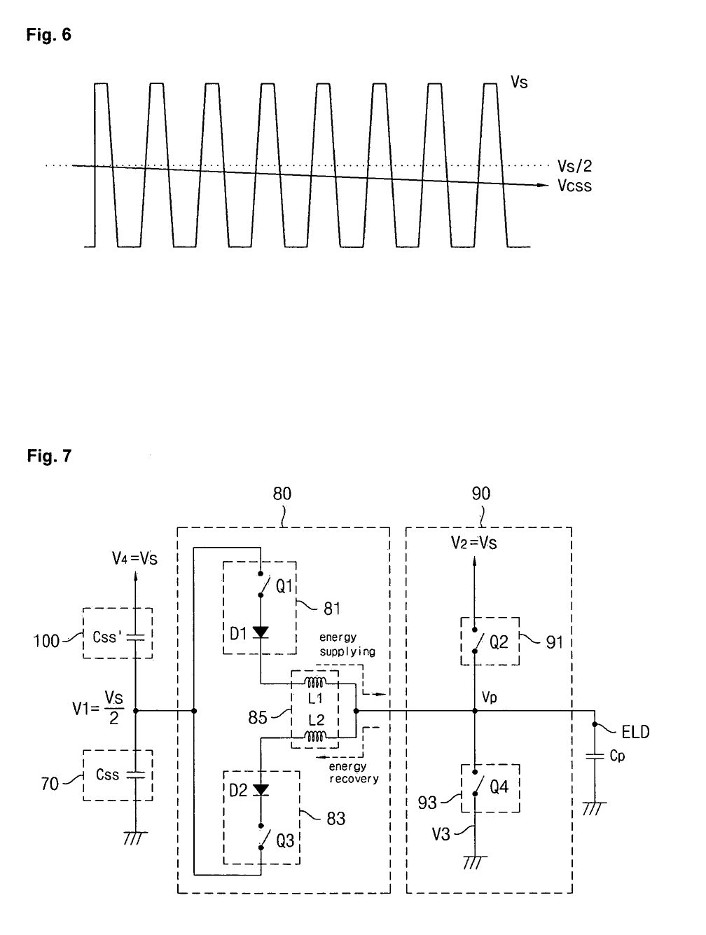

### DETAILED DESCRIPTION OF PREFERRED EMBODIMENTS

Preferred embodiments of the present invention will be described in a more detailed manner with reference to the drawings.

A plasma display apparatus of the present invention comprises a plasma display panel including an electrode; an energy supply and recovery unit which supplies and recovers the energy corresponding to a first voltage; an energy supply and recovery control unit which is adapt to supply the energy corresponding to said first voltage supplied by said energy supply and recovery unit to the electrode (ELD) through a supply path having a first inductance, and to recover the energy corresponding to said first voltage from said electrode to said energy supply and recovery unit through a recovery path having a second inductance; a voltage apply unit which applies a second voltage to said electrode after the energy corresponding to said first voltage is supplied to said electrode, and applies a third voltage to said electrode after the energy corresponding to said first voltage is recovered to said electrode; and a voltage maintenance unit which distributes a fourth voltage and maintains said first voltage constantly.

Said energy supply and recovery control unit is adapt to supply the energy corresponding to said first voltage supplied by said energy supply and recovery unit to the electrode through a supply path having a first inductance, and to recover the energy corresponding to said first voltage from said electrode to said energy supply and recovery unit through a recovery path having a second inductance higher than said first inductance.

Said volatage maintenance unit includes a capacitor for control of the voltage which divides said fourth voltage to apply said first voltage to said energy supply and recovery unit.

Said energy supply and recovery unit includes a capacitor for supply and recovery, said voltage maintenance unit includes a capacitor for control of the voltage, and one end of said capacitor for control of the voltage is applied with said fourth voltage, and the other end of said capacitor for control of the voltage is connected to one end of said capacitor for supply and recovery.

Said capacitor for control of the voltage has the same capacitance as the capacitance of said capacitor for supply and recovery.

Said energy supply and recovery control unit comprises, an energy supply control unit which forms a path to supply the energy stored in said energy store unit to said plasma display panel, an energy recovery control unit which forms a path to recover the energy from said plasma display panel to said energy store unit, and an inductor unit including a first inductor having a first inductance in which the energy inputted through said energy supply control unit flows and a second inductor having a second inductance in which the energy inputted in said energy recovery control unit flows.

A plasma display apparatus further comprises an energy supply control unit which forms a path to supply the energy stored in said energy store unit to said plasma display panel, an energy recovery control unit which forms a path to recover the energy from said plasma display panel to said energy store unit, and an inductor unit including a fourth inductor having a fourth inductance in which the energy inputted through said energy supply control unit flows and a third inductor allowing the energy inputted in said energy recovery control unit to flow into said fourth inductor.

Said second voltage and said fourth voltage are sustain voltages which are capable to maintain a sustain discharge, and said first voltage is 0.5 times as much as said sustain voltage.

A plasma display apparatus according to the present invention comprises a plasma display panel including an electrode; an energy supply and recovery unit which supplies and recovers the energy corresponding to a first voltage; an energy supply and recovery control unit which is adapt to supply the energy corresponding to said first voltage supplied by said energy supply and recovery unit to the electrode(ELD) through a supply path having a first inductance, and to recover the energy corresponding to said first voltage from said electrode to said energy supply and recovery unit through a recovery path having a second inductance; a voltage apply unit which applies a second voltage to said electrode after the energy corresponding to said first voltage is supplied to said electrode, and applies a third voltage to said electrode after the energy corresponding to said first voltage is recovered to said electrode; and a voltage maintenance unit including a capacitor for control of the voltage which divides a fourth voltage to apply said first voltage to said energy supply and recovery unit.

Said energy supply and recovery control unit is adapt to supply the energy corresponding to said first voltage supplied by said energy supply and recovery unit to the electrode through a supply path having a first inductance, and to recover the energy corresponding to said first voltage from said electrode to said energy supply and recovery unit through a recovery path having a second inductance higher than said first inductance.

Said energy supply and recovery unit includes a capacitor for supply and recovery, and one end of said capacitor for control of the voltage is applied with said fourth voltage, and the other end of said capacitor for control of the voltage is connected to one end of said capacitor for supply and recovery.

Said capacitor for control of the voltage has the same capacitance as the capacitance of said capacitor for supply and recovery.

Said energy supply and recovery control unit comprises an energy supply control unit which forms a path to supply the energy stored in said energy store unit to said plasma display panel, an energy recovery control unit which forms a path to recover the energy from said plasma display panel to said energy store unit, and an inductor unit including a first inductor having a first inductance in which the energy inputted through said energy supply control unit flows and a second inductor having a second inductance in which the energy inputted in said energy recovery control unit flows.

A plasma display apparatus comprises an energy supply control unit which forms a path to supply the energy stored in said energy store unit to said plasma display panel, an energy recovery control unit which forms a path to recover the energy from said plasma display panel to said energy store unit, and an inductor unit including a fourth inductor having a fourth inductance in which the energy inputted through said energy supply control unit flows and a third inductor allowing the energy inputted in said energy recovery control unit to flow into said fourth inductor.

Said second voltage and said fourth voltage are sustain voltages which are capable to maintain a sustain discharge, and said first voltage is 0.5 times as much as said sustain voltage.

A driving device of a plasma display panel of the present invention comprises a plasma display panel including an electrode; an energy supply and recovery unit which supplies and recovers the energy corresponding to a first voltage; an energy supply and recovery control unit which is adapt to supply the energy corresponding to said first voltage supplied by said energy supply and recovery unit to said electrode through a supply path having a first inductance, and to recover the energy corresponding to said first voltage from said electrode to said energy supply and recovery unit through a recovery path having a second inductance; a voltage apply unit which applies a second voltage to said electrode after the energy corresponding to said first voltage is supplied to said electrode, and applies a third voltage to said electrode after the energy corresponding to said first voltage is recovered to said electrode; and a voltage maintenance unit which distributes a fourth voltage and maintains said first voltage constantly.

Said voltage maintenance unit includes a capacitor for control of the voltage which divides said fourth voltage to apply said first voltage to said energy supply and recovery unit.

Said energy supply and recovery unit includes a capacitor for supply and recovery, said voltage maintenance unit includes a capacitor for control of the voltage, and one end of said capacitor for control of the voltage is applied with said fourth voltage, and the other end of said capacitor for control of the voltage is connected to one end of said capacitor for supply and recovery.

Said capacitor for control of the voltage has the same capacitance as the capacitance of said capacitor for supply and recovery.

Said second voltage and said fourth voltage are sustain voltages which are capable to maintain a sustain discharge, and said first voltage is 0.5 times as much as said sustain voltage.

Specific embodiments according to the present invention will be described hereinafter with reference to the accompanying drawings.

### A First Embodiment

FIG. 7 is a circuit of a plasma display apparatus according to a first embodiment of the present invention. As shown in FIG. 7, the plasma display apparatus according to the first embodiment of the present invention includes a plasma display panel Cp, an energy supply and recovery unit 70, an energy supply and recovery control unit 80, a voltage apply unit 90, and a voltage maintenance unit 100.

The plasma display panel Cp includes an electrode ELD.

The energy supply and recovery unit 70 supplies and recovers the energy corresponding to a first voltage V1. At this time, the first voltage V1 is preferably 0.5 times as much as a sustain voltage Vs to maintain the discharge of the plasma display panel. The energy supply and recovery unit 70 includes a capacitor Css for supply and recovery in which the energy needed for the sustain discharge is stored.

The energy supply and recovery control unit 80 is adapt to supply the electrode ELD with the energy corresponding to the first voltage supplied by the energy supply and recovery unit 70 through a supply path having a first inductance by resonance, and to allow the energy corresponding to the first voltage to be recovered from the electrode ELD to the energy supply and recovery unit 70 through a recovery path having a second inductance by resonace.

This energy supply and recovery control unit 80 includes an energy supply control unit 81, an energy recovery control unit 83, and an inductor unit 85.

The energy supply control unit 81 includes a first swith Q1 and a first diode D1. Turning on the first switch Q1 forms a path to supply the energy stored in the capacitor Css for supply and recovery in the energy store unit 70 to the panel Cp. One end of this first switch Q1 is connected to one end of the capacitor Css for supply and recovery. The first diode D1 prohibits the reverse current from flowing from the panel Cp via the first switch Q1 to the capacitor Css for supply and recovery. The anode terminal of this first diode D1 is connected to the other end of the first switch Q1.

The energy recovery control unit 83 includes a third switch Q3 and a second diode D2. Turning on the third switch Q3 forms a path to recover the energy from the panel Cp to the capacitor Css for supply and recovery in the energy store unit 70. One end of this third switch Q3 is commonly connected to one end of the capacitor Css for supply and recovery and one end of the first switch Q1. The second diode D2 prohibits the reverse current from flowing from the capacitor Css for supply and recovery via the third switch Q3 to the panel Cp. The cathode terminal of this first diode D2 is connected to the other end of the third switch Q3.

The inductor unit 85 along with the panel Cp constitutes a series LC resonance circuit, and includes a first inductor L1 having a first inductance in which the energy inputted through the energy supply control unit 81 flows and a second inductor L2 having a second inductance in which the energy inputted into the energy recovery control unit 83 flows. At this time, the first inductance is smaller than the second inductance. One end of the first inductor L1 is connected to the cathode terminal of the first diode D1, and the other end of the first inductor L1 is connected to the electrode ELD of the panel Cp. In addition, one end of the second inductor L2 is connected to the anode terminal of the second diode D2, and the other end of the second inductor L2 is connected to the electrode ELD of the panel Cp.

The voltage apply unit 90 applies the second voltage V2 to the electrode ELD after the energy corresponding to the first voltage was supplied to the electrode ELD by resonance, and applies the third voltage V3 to the electrode ELD after the energy corresponding to the first energy V1 was recovered from the electrode ELD by resonance. At this time, the first voltage is preferably equal to the sustain voltage Vs, the third voltage V3 is preferably equal to ground level voltage. This voltage apply unit 90 applies the second voltage V2 to the electrode ELD by turning on the second switch Q2, and applies the third voltage V3 to the electrode ELD by turning on the fourth switch Q4.

The voltage maintenance unit 100 distributes the fourth voltage V4 to thereby maintain the first voltage V1 constantly. The voltage maintenance unit 86 includes a capacitor Css′ for control of the voltage. One end of the capacitor Css′ for control of the voltage is applied with the fourth voltage, and the other end of the capacitor Css′ for control of the voltage is connected to one end of the capacitor Css for supply and recovery in the energy store unit 70. As such, the capacitor Css′ for control of the voltage is connected in series with the capacitor Css for supply and recovery to thereby distribute the fourth voltage. In the case that the fourth voltage is equal to the sustain voltage Vs, the capacitor Css′ for control of the voltage has the same capacitance as the capacitor Css for supply and recovery in order that 0.5 times as much as the sustain voltage is applied to the capacitor Css for supply and recovery.

The operation of the first embodiment of the present invention is as follow.

In energy supply step, the first switch Q1 is turned on, and the other switches, i.e. the second switch to the fourth switch Q2, Q3, Q4 are all turned off. Accordingly, the energy stored in the capacitor Css for supply and recovery is supplied to the panel Cp. The path where the energy is supplied is from the capacitor Css for supply and recovery via the first switch Q1—the first diode D1—the first inductor L1 of inductor unit 85 to the panel Cp.

In the sustain voltage maintain step, first switch Q1 and the second switch Q2 are turne on, and the other switches, i.e. the third switch Q3 and the fourth switch Q4 are turned off. Accordingly, the sustain voltage Vs is maintained in the panel Cp.

In the enery recovery step, the third switch Q3 is turned on, the other switches, i.e. the first, the second, and the fourth switches Q1, Q2, Q4 are turend off. Accordingly, the component of the reactive power of the panel is recovered from the capacitor Css for supply and recovery upon the discharge. The path where the energy is recovered is from the panel Cp via the second inductor L2 of the inductor unit 85—the second diode D2—the third switch Q3 to the capacitor Css for supply and recovery.

In this process, the first inductor L1 is saturated to thereby lead to the loss of charges in the capacitor Css for supply and recovery, or the energy stored in the second inductor L2 is relatively increased to thereby enable only smaller amounts of charges than capacitance to be recovered to the capacitor Css for supply and recovery. As such, in the case that the energy below Vs/2 is recovered and stored into the capacitor Css, the voltage maintenance unit 100 drops the fourth voltage equal to the sustain voltage (V4=Vs) by Vs/2, so that it causes the Vs/2 of voltage to be applied to the capacitor Css for supply and recovery. Thus, the voltage applied to the capacitor Css for supply and recovery maintains Vs/2. In other words, in the case that the energy is charged to the capacitor Css for supply and recovery, the energy of Vs/2 of the voltage is always charged.

In the base voltage maintenance step, the third and the fourth switches Q3, Q4 are turned on, and the first and the second switches Q1, Q2 are turned off. Accordingly, the voltage applied to the panel Cp becomes the ground level GND.

### A Second Embodiment

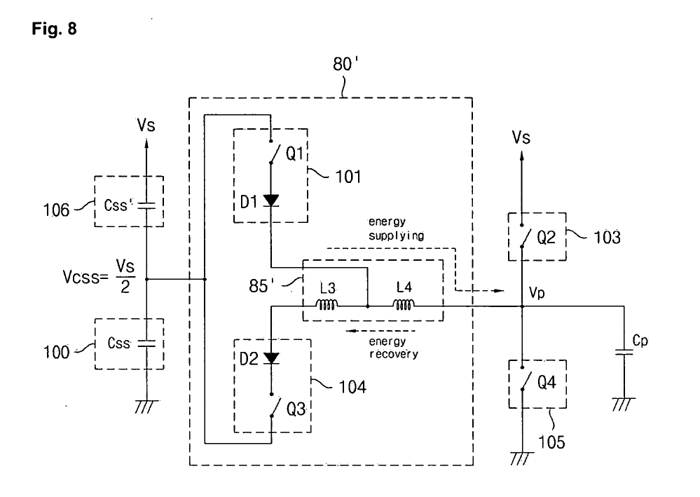

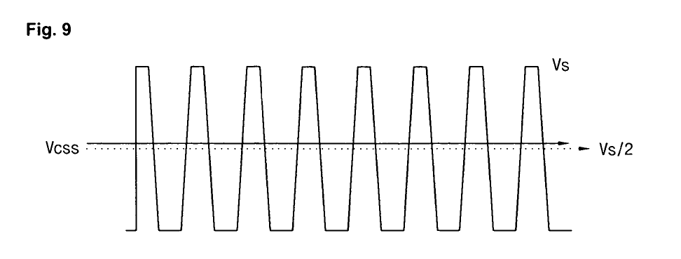

FIG. 8 is a circuit of a plasma display apparatus according to a second embodiment of the present invention. As shown in FIG. 8, the display apparatus according to the second embodiment of the present invention differs in the inductor unit in comparison with the first embodiment.

In other words, the inductor unit 85 of the first embodiment includes the first inductor L1 and the second inductor L2, each of which has a different inductance from each other. At this time, the first inductor L1 is included in the energy supply path, while the second inductor L2 is included in the energy recovery path.

On the other hand, the inductor unit 85′ of the second embodiment includes a third inductor L3 and a fourth inductor L4. At this time, the fourth inductor L4 is included in the energy supply path, and the fourth inductor L4 and the third inductor L3 are included in the energy recovery path. Accordingly, the energy related to resonance is sum of the third inductance and the fourth inductance in the energy recovery process.

One end of this fourth inductor L4 is connected to the cathode terminal of the first diode D1 and the other end of the fourth inductor L4 is connected to the electrode ELD of the panel Cp. In addition, one of the third inductor L3 is connected to the anode terminal of the second diode D2, and the other end of the third inductor L3 is connected to one end of the fourth inductor L4.

The operation of the second embodiment of the present invention is as follow.

In energy supply step, the first switch Q1 is turned on, the other switches, i.e. the second switch to the fourth switch Q2, Q3, Q4 are all turned off. Accordingly, the energy stored in the capacitor Css for supply and recovery is supplied to the panel Cp. The path where the energy is supplied is from the capacitor Css for supply and recovery via the first switch Q1-the first diode D1-the fourth inductor L4 of inductor unit 85′ to the panel Cp.

In the sustain voltage maintain step, the first switch Q1 and the second switch Q2 are turne on, the other switches, i.e. the third switch Q3 and the fourth switch Q4 are turned off. Accordingly, the sustain voltage Vs is maintained in the panel Cp.

In the enery recovery step, the third switch Q3 is turned on, the other switches, i.e. the first, the second, and the fourth switches Q1, Q2, Q4 are turend off. Accordingly, the component of the reactive power of the panel is recovered from the capacitor Css for supply and recovery upon the discharge. The path where the energy is recovered is from the panel Cp via the fourth inductor L4 of the inductor unit 85′-the third inductor L3 of the inductor unit 85′—the second diode D2—the third switch Q3 to the capacitor Css for supply and recovery.

In this process, the fourth inductor L4 is saturated to thereby lead to the loss of charges in the capacitor Css for supply and recovery, or the energy stored in the fourth L4 and the third inductor L3 is relatively increased to thereby enable only smaller quantity of charges than capacitance to be recovered to the capacitor Css for supply and recovery. As such, in the case that the energy below Vs/2 is recovered and stored into the capacitor Css, the voltage maintenance unit 100 drops the fourth voltage equal to the sustain voltage (V4=Vs) by Vs/2, so that it causes the Vs/2 of voltage to be applied to the capacitor Css for supply and recovery. Thus, the voltage applied to the capacitor Css for supply and recovery maintains Vs/2. In other words, in the case that the energy is charged to the capacitor Css for supply and recovery, the energy of Vs/2 of the voltage is always charged.

In the base voltage maintain step, the third and fourth switches Q3, Q4 are turned on, and the first and second switches are turned off. Accordingly, the voltage applied to the panel Cp becomes the ground level GND.

FIG. 9 is a driving waveform of a plasma display apparatus according to the present invention. As shown in FIG. 9, in the plasma display apparatus according to the present invention, although the switching time of the energy supplay and the energy recovery is different from each other, and the energy supply path and the energy recovery path is different from each other, respectively, the first voltage V1 applied to the capacitor Css for supply and recovery is maintained constantly as Vs/2.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel including an electrode;
an energy supply and recovery unit which supplies and recovers the energy corresponding to a first voltage;
an energy supply and recovery control unit which is adapt to supply the energy corresponding to said first voltage supplied by said energy supply and recovery unit to the electrode (ELD) through a supply path having a first inductance, and to recover the energy corresponding to said first voltage from said electrode to said energy supply and recovery unit through a recovery path having a second inductance;
a voltage apply unit which applies a second voltage to said electrode after the energy corresponding to said first voltage is supplied to said electrode, and applies a third voltage to said electrode after the energy corresponding to said first voltage is recovered to said electrode; and
a voltage maintenance unit which distributes a fourth voltage and maintains said first voltage constantly.

2. A plasma display apparatus as claimed in claim 1, wherein
the energy supply and recovery control unit is adapt to supply the energy corresponding to said first voltage supplied by said energy supply and recovery unit to the electrode through a supply path having a first inductance, and to recover the energy corresponding to said first voltage from said electrode to said energy supply and recovery unit through a recovery path having a second inductance higher than said first inductance.

3. A plasma display apparatus as claimed in claim 1, wherein
the volatage maintenance unit includes a capacitor for control of the voltage which divides said fourth voltage to apply said first voltage to said energy supply and recovery unit.

4. A plasma display apparatus as claimed in claim 1, wherein
the energy supply and recovery unit includes a capacitor for supply and recovery, said voltage maintenance unit includes a capacitor for control of the voltage, and
one end of said capacitor for control of the voltage is applied with said fourth voltage, and the other end of said capacitor for control of the voltage is connected to one end of said capacitor for supply and recovery.

5. A plasma display apparatus as claimed in claim 4, wherein
the capacitor for control of the voltage has the same capacitance as the capacitance of said capacitor for supply and recovery.

6. A plasma display apparatus as claimed in claim 1, wherein
the energy supply and recovery control unit comprises,
an energy supply control unit which forms a path to supply the energy stored in said energy store unit to said plasma display panel, an energy recovery control unit which forms a path to recover the energy from said plasma display panel to said energy store unit, and an inductor unit including a first inductor having a first inductance in which the energy inputted through said energy supply control unit flows and a second inductor having a second inductance in which the energy inputted in said energy recovery control unit flows.

7. A plasma display apparatus as claimed in claim 1, further comparising
an energy supply control unit which forms a path to supply the energy stored in said energy store unit to said plasma display panel, an energy recovery control unit which forms a path to recover the energy from said plasma display panel to said energy store unit, and an inductor unit including a fourth inductor having a fourth inductance in which the energy inputted through said energy supply control unit flows and a third inductor allowing the energy inputted in said energy recovery control unit to flow into said fourth inductor.

8. A plasma display apparatus as claimed in claim 1, wherein
the second voltage and said fourth voltage are sustain voltages which are capable to maintain a sustain discharge,
said first voltage is 0.5 times as much as said sustain voltage.

9. A plasma display apparatus comprising:
a plasma display panel including an electrode;
an energy supply and recovery unit which supplies and recovers the energy corresponding to a first voltage;
an energy supply and recovery control unit which is adapt to supply the energy corresponding to said first voltage supplied by said energy supply and recovery unit to the electrode (ELD) through a supply path having a first inductance, and to recover the energy corresponding to said first voltage from said electrode to said energy supply and recovery unit through a recovery path having a second inductance;
a voltage apply unit which applies a second voltage to said electrode after the energy corresponding to said first voltage is supplied to said electrode, and applies a third voltage to said electrode after the energy corresponding to said first voltage is recovered to said electrode; and
a voltage maintenance unit including a capacitor for control of the voltage which divides a fourth voltage to apply said first voltage to said energy supply and recovery unit.

10. A plasma display apparatus as claimed in claim 9, wherein
the energy supply and recovery control unit is adapt to supply the energy corresponding to said first voltage supplied by said energy supply and recovery unit to the electrode through a supply path having a first inductance, and to recover the energy corresponding to said first voltage from said electrode to said energy supply and recovery unit through a recovery path having a second inductance higher than said first inductance.

11. A plasma display apparatus as claimed in claim 9, wherein
The energy supply and recovery unit includes a capacitor for supply and recovery, and
one end of said capacitor for control of the voltage is applied with said fourth voltage, and the other end of said capacitor for control of the voltage is connected to one end of said capacitor for supply and recovery.

12. A plasma display apparatus as claimed in claim 11, wherein
the capacitor for control of the voltage has the same capacitance as the capacitance of said capacitor for supply and recovery.

13. A plasma display apparatus as claimed in claim 9, wherein
the energy supply and recovery control unit comprises,
an energy supply control unit which forms a path to supply the energy stored in said energy store unit to said plasma display panel, an energy recovery control unit which forms a path to recover the energy from said plasma display panel to said energy store unit, and an inductor unit including a first inductor having a first inductance in which the energy inputted through said energy supply control unit flows and a second inductor having a second inductance in which the energy inputted in said energy recovery control unit flows.

14. A plasma display apparatus as claimed in claim 9, further comparising
an energy supply control unit which forms a path to supply the energy stored in said energy store unit to said plasma display panel, an energy recovery control unit which forms a path to recover the energy from said plasma display panel to said energy store unit, and an inductor unit including a fourth inductor having a fourth inductance in which the energy inputted through said energy supply control unit flows and a third inductor allowing the energy inputted in said energy recovery control unit to flow into said fourth inductor.

15. A plasma display apparatus as claimed in claim 9, wherein
the second voltage and said fourth voltage are sustain voltages which are capable to maintain a sustain discharge,
said first voltage is 0.5 times as much as said sustain voltage.

16. A driving device of a plasma display panel includeing an electrode, said plasma display panel comprising:
a plasma display panel including an electrode;
an energy supply and recovery unit which supplies and recovers the energy corresponding to a first voltage;
an energy supply and recovery control unit which is adapt to supply the energy corresponding to said first voltage supplied by said energy supply and recovery unit to said electrode through a supply path having a first inductance, and to recover the energy corresponding to said first voltage from said electrode to said energy supply and recovery unit through a recovery path having a second inductance;
a voltage apply unit which applies a second voltage to said electrode after the energy corresponding to said first voltage is supplied to said electrode, and applies a third voltage to said electrode after the energy corresponding to said first voltage is recovered to said electrode; and
a voltage maintenance unit which distributes a fourth voltage and maintains said first voltage constantly.

17. A driving device of a plasma display apparatus as claimed in claim 16, wherein
the volatage maintenance unit includes a capacitor for control of the voltage which divides said fourth voltage to apply said first voltage to said energy supply and recovery unit.

18. A driving device of a plasma display apparatus as claimed in claim 16, wherein the energy supply and recovery unit includes a capacitor for supply and recovery, said voltage maintenance unit includes a capacitor for control of the voltage, and
one end of said capacitor for control of the voltage is applied with said fourth voltage, and the other end of said capacitor for control of the voltage is connected to one end of said capacitor for supply and recovery.

19. A driving device of a plasma display apparatus as claimed in claim 18, wherein
the capacitor for control of the voltage has the same capacitance as the capacitance of said capacitor for supply and recovery.

20. A driving device of a plasma display apparatus as claimed in claim 16, wherein
the second voltage and said fourth voltage are sustain voltages which are capable to maintain a sustain discharge,
said first voltage is 0.5 times as much as said sustain voltage.
